(19) United States
(12) Patent Application Publication
(10) Pub. No.: US 2020/0089639 A1
(43) Pub. Date: Mar. 19, 2020

(54) INFORMATION PROCESSING APPARATUS

(71) Applicant: FUJI XEROX CO., LTD., Tokyo (JP)

(72) Inventors: Takanori FUKUOKA, Kanagawa (JP); Kenji IMAMURA, Kanagawa (JP); Masahiro KOBATA, Kanagawa (JP); Yuji MURATA, Kanagawa (JP); Kazuhiko ABE, Kanagawa (JP); Shinho IKEDA, Kanagawa (JP)

(73) Assignee: FUJI XEROX CO., LTD., Tokyo (JP)

(21) Appl. No.: 16/565,444

(22) Filed: Sep. 9, 2019

(30) Foreign Application Priority Data
Sep. 19, 2018 (JP) 2018-174949

(51) Int. Cl. G06F 13/40; G06F 13/20

(52) U.S. Cl. CPC G06F 13/40; G06F 13/20

(57) ABSTRACT

An information processing apparatus includes a first controller that has a first interface and performs control that does not depend on hardware; a second controller that has a second interface connected to the first interface, is connected to the first controller through a communication path, and performs control that depends on the hardware; and a matching unit that, in a case where there is mismatch between first pin definition of the first interface and second pin definition of the second interface, causes a function of the first controller and a function of the second controller to match each other by changing the first pin definition or the second pin definition so that the first pin definition and the second pin definition match each other.

### CROSS-REFERENCE TO RELATED APPLICATIONS

This application is based on and claims priority under 35 USC 119 from Japanese Patent Application No. 2018-174949 filed Sep. 19, 2018.

### BACKGROUND

### (i) Technical Field

The present disclosure relates to an information processing apparatus.

### (ii) Related Art

In an information processing apparatus such as an image forming apparatus, a versatile first controller that does not depend on hardware included in the information processing apparatus and a dedicated second controller that depends on the hardware included in the information processing apparatus are sometimes provided so that the first controller and the second controller play different roles of a controller. For example, the first controller and the second controller are connected to each other through user interfaces of the first controller and the second controller.

Japanese Unexamined Patent Application Publication No. 2004-287993 describes a method for prohibiting operation of a system or an apparatus constituted by a combination of plural devices in a case where there is mismatch between versions of the devices.

Japanese Unexamined Patent Application Publication No. 2014-120057 describes an apparatus that allocates a general-purpose driver as a device driver for an external device connected to an interface in a case where there is a device driver corresponding to device identification information of the external device and the interface is controllable.

### SUMMARY

In a case such as a case where a version of any one of a first controller and a second controller is changed or a case where a new function is added to any one of the first controller and the second controller, specifications of an interface of the one of the controllers are sometimes changed. In this case, interface mismatch occurs between the one controller whose interface specifications have been changed and the other controller. This can cause a situation where an information processing apparatus including the first controller and the second controller does not function due to the mismatch.

Aspects of non-limiting embodiments of the present disclosure relate to providing an information processing apparatus in which a first controller that performs control that does not depend on hardware and a second controller that performs control that depends on the hardware are connected to each other by interfaces of the first and second controllers, in which a function of the information processing apparatus can be used as compared with a case where a function of an information processing apparatus is completely stopped upon occurrence of mismatch between interfaces.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a first controller that has a first interface and performs control that does not depend on hardware; a second controller that has a second interface connected to the first interface, is connected to the first controller through a communication path, and performs control that depends on the hardware; and a matching unit that, in a case where there is mismatch between first pin definition of the first interface and second pin definition of the second interface, causes a function of the first controller and a function of the second controller to match each other by changing the first pin definition or the second pin definition so that the first pin definition and the second pin definition match each other.

### BRIEF DESCRIPTION OF THE DRAWINGS

An exemplary embodiment of the present disclosure will be described in detail based on the following figures, wherein:

FIG. 1 is a block diagram illustrating an image forming apparatus according to an exemplary embodiment of the present disclosure;

FIG. 2 illustrates an ID table of a system controller and an ID table of a device controller;

FIG. 3 illustrates contents of settings of registers for pins;

FIG. 4 is a flowchart concerning function matching processing;

FIG. 5 illustrates Specific Example 1;

FIG. 6 illustrates Specific Example 2;

FIG. 7 illustrates Specific Example 3; and

FIG. 8 illustrates Specific Example 4.

### DETAILED DESCRIPTION

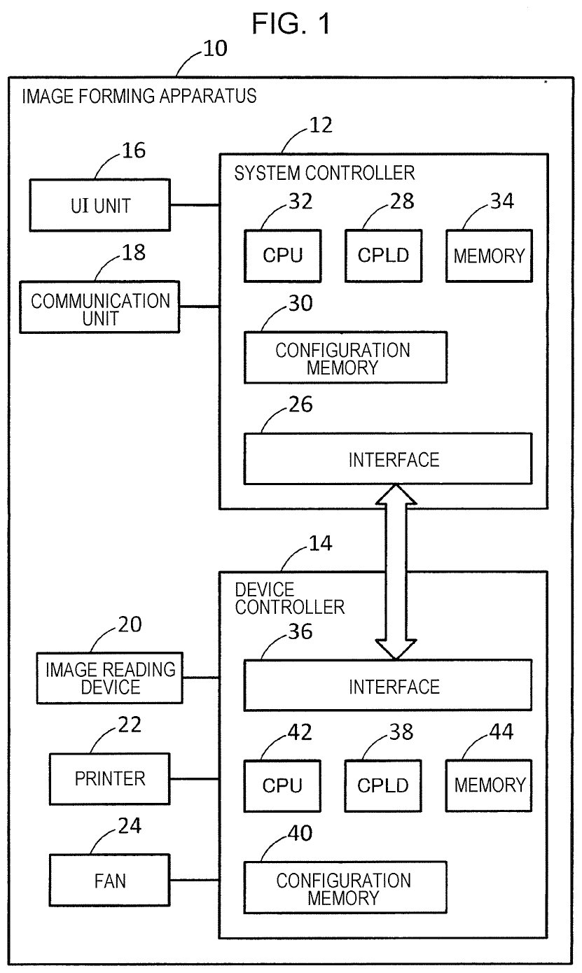

An image forming apparatus that is an example of an information processing apparatus according to the present exemplary embodiment is described with reference to FIG. 1. FIG. 1 illustrates an example of the image forming apparatus according to the present exemplary embodiment. The information processing apparatus according to the present exemplary embodiment is not limited to an image forming apparatus 10 and may be, for example, any of appliances in general such as information appliances, video appliances, audio appliances, and other kinds of appliances. In the following description, the image forming apparatus 10 is used as an example of the information processing apparatus.

The image forming apparatus 10 is an apparatus that has an image forming function. Specifically, the image forming apparatus 10 is an apparatus that has at least one of a scan function (an image reading function), a print function, a copy function, and a facsimile function. The following describes a configuration of the image forming apparatus 10 in detail.

The image forming apparatus 10 includes one or more pieces of hardware having a function, a system controller 12, and a device controller 14. The system controller 12 is an example of a first controller, and the device controller 14 is an example of a second controller.

The system controller 12 and the device controller 14 are connected to each other through a communication path such as a bus (e.g., a high-speed bus such as PCI Express) and transmit and receive various kinds of information to and from each other. For example, information such as command information indicative of a command to execute processing, status information indicative of statuses of the controllers, and information indicative of a detection result of a sensor or the like may be exchanged between the system controller 12 and the device controller 14. A format of the information exchanged between the system controller 12 and the device controller 14 may be a format selected from among predetermined plural formats. Furthermore, the system controller 12 and the device controller 14 may be connected to each other through a dedicated line and exchange information such as information for synchronizing the system controller 12 and the device controller 14.

The image forming apparatus 10 that is an example of the information processing apparatus includes, as examples of the hardware, a UI unit 16, a communication unit 18, an image reading device 20, a printer 22, and a fan 24.

The UI unit 16 is a user interface and includes a display unit and an operation unit. The display unit is, for example, a display device such as a liquid crystal display or an EL display. The operation unit is, for example, an input device such as a keyboard. The UI unit 16 may be a user interface (e.g., a touch panel or an operation panel) that functions as both a display unit and an operation unit.

The communication unit 18 is a communication interface and has a function of transmitting information to another apparatus through a communication path and a function of receiving information transmitted from another apparatus. The communication may be wireless communication or may be wired communication.

The image reading device 20 is, for example, a scanner and is a device that generates image data representing a document by reading the document.

The printer 22 is, for example, a printer and is a device that receives image data, document data, and the like and forms an image, a document, and the like on a recording medium such as a sheet of paper.

The fan 24 is a device for cooling an inside of the image forming apparatus 10.

In addition, the image forming apparatus 10 may include a storage device such as a hard disk and a memory, and the like. In the storage device, for example, various kinds of data (e.g., image data generated by scan and image data to be printed) and various kinds of programs are stored. Needless to say, other kinds of hardware may be included in the image forming apparatus 10.

The system controller 12 includes an interface 26, a complex programmable logic device (CPLD) 28 that is an example of a programmable logic device (dynamically reconfigurable circuit), a configuration memory 30, a central processing unit (CPU) 32 that is an example of a processor, and a storage unit 34.

The interface 26 is a member that physically connects the system controller 12 and the device controller 14. The interface 26 has plural pins. As described later, the device controller 14 also has an interface 36 having plural pins. The interface 26 and the interface 36 are connected to each other, and thus the system controller 12 and the device controller 14 are physically connected. The interfaces 26 and 36 may be interfaces for parallel connection or may be interfaces for serial connection. The interface 26 is an example of a first interface.

In the configuration memory 30, a program file (configuration data) that is an information source of a circuit realized on the CPLD 28 is stored. The circuit realized on the CPLD 28 is dynamically changed in accordance with the program file stored in the configuration memory 30. The program file (configuration data) is an example of control information (control program) for realizing a function. In a case where a program file for realizing a certain function is stored in the configuration memory 30, a circuit for realizing the function is constructed on the CPLD 28.

The CPU 32 functions, for example, as a controller and is configured to control operation of the system controller 12.

The storage unit 34 is a storage region constituted by a register, a memory, a hard disk drive, and the like. In the present exemplary embodiment, registers for pins used in the interface 26 are provided. The registers for pins are connected to the respective pins that constitute the interface 26 and store therein information indicative of mount states (e.g., whether or not the pins are mounted and whether or not the pins are being used) of the pins as contents of settings of the pins. Furthermore, in the storage unit 34, an ID table (attribute information) indicative of an ID of the system controller 12 is stored.

The system controller 12 has a function of performing processing that does not depend on hardware included in the image forming apparatus 10, i.e., a function of controlling a common part that does not depend on a type of each hardware part, an individual difference of each hardware part, a difference between products, and the like. For example, the system controller 12 performs processing such as display and input processing on the UI unit 16 serving as hardware, communication using the communication unit 18, processing of image data and appliance information, image processing, user authentication processing, and a management of a memory (e.g., reading of an SD card). The above function is, for example, realized by the CPLD 28.

For example, the system controller 12 sends command information (e.g., a job such as a print job or a copy job) indicative of a command to execute processing to the device controller 14. The execution command is an execution command having a format that does not depend on hardware and is, for example, a command written in a language that can be understood by a user. The command information is stored in the device controller 14.

The device controller 14 includes an interface 36, a CPLD 38 that is an example of a programmable logic device (dynamically reconfigurable circuit), a configuration memory 40, a CPU 42 that is an example of a processor, and a storage unit 44.

The interface 36 is a member for physically connecting the system controller 12 and the device controller 14. The interface 36 has plural pins. As described above, the interface 26 and the interface 36 are connected to each other, and thus the system controller 12 and the device controller 14 are physically connected. The interface 36 is an example of a second interface.

In the configuration memory 40, a program file (configuration data) that is an information source of a circuit realized on the CPLD 38 is stored. The circuit realized on the CPLD 38 is dynamically changed in accordance with the program file stored in the configuration memory 40. In a case where a program file for realizing a certain function is stored in the configuration memory 40, a circuit for realizing the function is constructed on the CPLD 38.

The CPU 42 functions, for example, as a controller and is configured to control operation of the device controller 14.

The storage unit 44 is a storage region constituted by a register, a memory, a hard disk drive, and the like. In the present exemplary embodiment, registers for pins used in the interface 36 are provided. The registers for pins are connected to the respective pins that constitute the interface 36 and store therein information indicative of mount states (e.g., whether or not the pins are mounted and whether or not the pins are being used) of the pins as contents of settings of the pins. Furthermore, in the storage unit 44, an ID table (attribute information) indicative of an ID of the device controller 14 is stored.

The device controller 14 has a function of performing processing that depends on hardware included in the image forming apparatus 10, i.e., a function of controlling a part unique to the hardware. For example, the device controller 14 performs processing such as control of the image reading device 20, control of the printer 22, control of the fan 24, control of a post-processing device such as a stapler, and control of a motor, a heater, a lamp, and the like based on information obtained, for example, by various kinds of sensors. The above function is, for example, realized by the CPLD 38.

For example, the device controller 14 executes processing designated by an execution command indicated by command information sent from the system controller 12. For example, in a case where execution of copy is designated by the execution command, the device controller 14 causes the image reading device 20 and the printer 22 to execute copy by controlling the image reading device 20 and the printer 22 in accordance with copy conditions (e.g., resolution, a sheet size, and the number of copies) designated by the command information.

In the present exemplary embodiment, in a case where there is mismatch between pin definition (hereinafter referred to as “first pin definition”) of the interface 26 and pin definition (hereinafter referred to as “second pin definition”) of the interface 36, the first pin definition or the second pin definition is changed so that the first pin definition and the second pin definition match each other, and thus a function of the system controller 12 and a function of the device controller 14 match each other. The change of the pin definition and matching of the functions may be performed by the CPU 32 or the CPLD 28 of the system controller 12 or may be performed by the CPU 42 or the CPLD 38 of the device controller 14.

In a case where a method of connection between the interfaces 26 and 36 is parallel connection, pin definition is decided by a combination of pins as hardware (physical pins) and contents of settings of registers for pins. In a case where a method of connection between the interfaces 26 and 36 is parallel connection, mismatch in pin definition occurs, for example, due to mismatch in physical pin configuration between the interfaces 26 and 36 and mismatch in contents of settings of a register between the interfaces 26 and 36.

In a case where a method of connection between the interfaces 26 and 36 is serial connection, pin definition is decided by contents of settings of registers. For example, mismatch in pin definition occurs due to mismatch in contents of settings of registers between the interfaces 26 and 36.

As described above, mismatch in pin definition occurs in a case where the interfaces 26 and 36 are different at least in contents of settings of registers.

For example, pin definition is changed by changing contents of settings of registers for pins. Furthermore, matching between a function of the system controller 12 and a function of the device controller 14 is achieved by adding a new function to the system controller 12 or the device controller 14 or restricting a function of the system controller 12 or the device controller 14.

For example, in a case where a new function is added to any one of the system controller 12 and the device controller 14, matching between functions of the controllers is achieved by adding the new function to the other one of the controllers. In a case where it is impossible to add the new function to the other one of the controllers, matching between the functions of the controllers is achieved by restricting the new function added to the one of the controllers.

Since the system controller 12 and the device controller 14 have different roles, a difference in development cycle between the system controller 12 and the device controller 14 may occur. In order to address the difference, a controller may be divided into the system controller 12 and the device controller 14 so that each controller is given a role.

The image forming apparatus 10 according to the present exemplary embodiment is described in detail below.

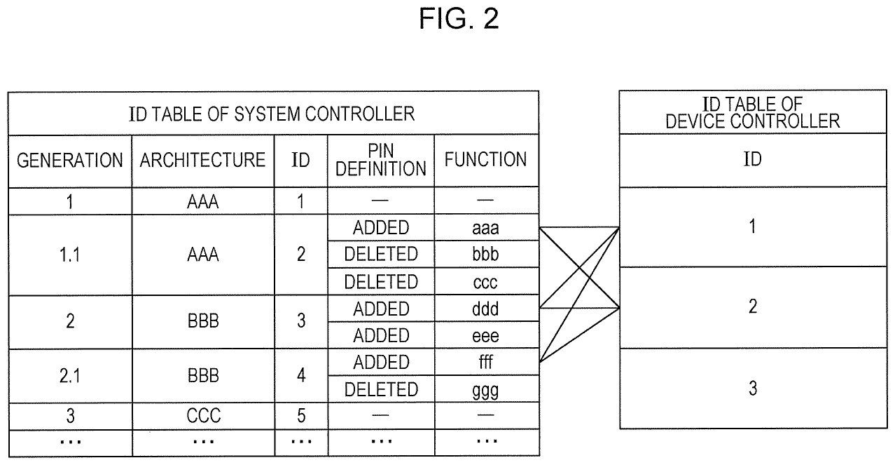

ID tables of the system controller 12 and the device controller 14 are described with reference to FIG. 2. FIG. 2 illustrates the ID tables. In the ID table of the system controller 12, for example, information indicative of a generation (version) of the system controller, information indicative of an architecture of the system controller 12, an ID for identifying the system controller 12, information indicative of addition or deletion of a pin included in the interface 26, and information indicative of a function realized by using the pin are associated with one another. In the ID table of the device controller 14, for example, an ID for identifying the device controller 14 is included. In addition, a name of a CPLD and the like may be included in each ID table. In the tables, a function and an ID of the device controller 14 corresponding to the function are connected by a line. A corresponding function of the controllers can be specified by referring to the ID tables.

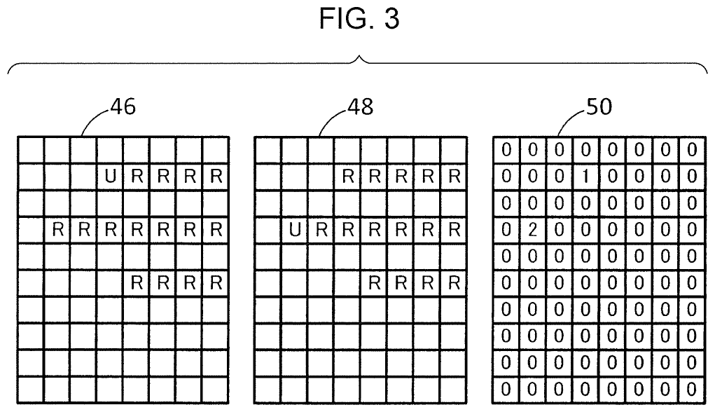

Contents of settings of registers for pins are described with reference to FIG. 3. FIG. 3 illustrates contents of settings of registers of the system controller 12 and contents of settings of registers of the device controller 14. A register 46 is a register of the system controller 12, and a register 48 is a register of the device controller 14. In the register 46, information indicative of contents of settings of the pins that constitute the interface 26 is stored. In the registers 48, information indicative of contents of settings of the pins that constitute the interface 36 is stored. For example, “U” (Used) means that a pin is being used, and a pin corresponding to a register in which information indicative of “U” is stored is being used. “R” (Reserve) means that a pin is not being used, and a pin corresponding to a register in which information indicative of “R” is stored is not being used. These pieces of information are stored in advance in the registers 46 and 48.

The concept “being used” encompasses a state where a physical pin is mounted in an interface. The concept “not being used” encompasses, for example, a state where a physical pin is mounted in an interface but is not being used and a state where a physical pin is not mounted in an interface. Information indicative of contents of settings of pins connected to each other is stored in the same storage region of the registers 46 and 48.

By comparing contents of settings of the register 46 and contents of settings of the register 48, a difference in contents of settings (e.g., a difference in presence or absence of pins) between the interfaces 26 and 36 is detected. The table 50 is a table indicative of the difference. “0” indicates that there is no difference in contents of settings of the registers. “1”, “2”, . . . etc. indicate that there is a difference in contents of settings of the registers. For example, a pin of the device controller 14 corresponding to (connected to) a pin (“U”) that is being used in the system controller 12 is not being used (“R”). In this way, by comparing the registers for pins of the system controller 12 and the registers for pins of the device controller 14, whether corresponding pins of the interfaces 26 and 36 are being used or not is specified. The register comparing processing may be performed by the CPU 32 of the system controller 12 or may be performed by the CPU 42 of the device controller 14.

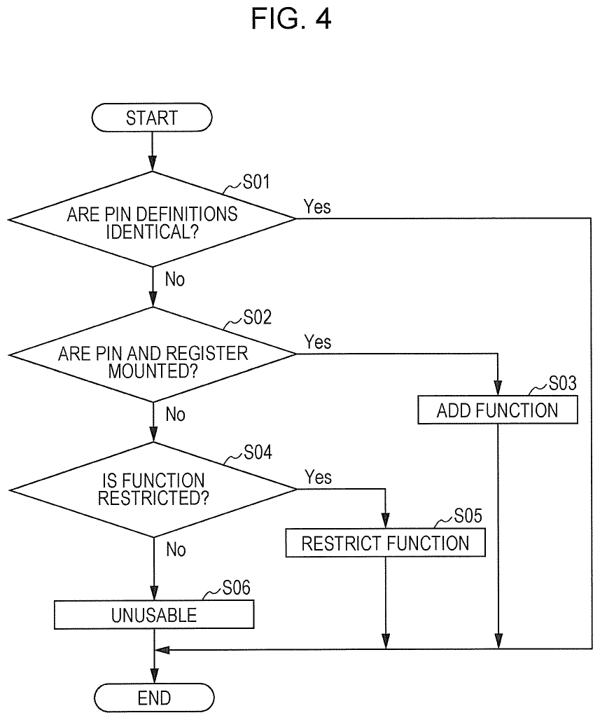

Function matching processing is described below with reference to FIG. 4. FIG. 4 is a flowchart concerning the function matching processing. Note that it is assumed that parallel connection is used as a method of connection between the interfaces 26 and 36.

First, the CPU 32 of the system controller 12 determines whether or not pin definition of the interface 26 and pin definition of the interface 36 are identical to each other by comparing contents of settings of the registers for pins of the system controller 12 and contents of settings of the registers for pins of the device controller 14 (Step S01). The CPU 42 of the device controller 14 may perform this determining processing.

In a case where the pin definition of the interface 26 and the pin definition of the interface 36 are identical to each other (Yes in Step S01), the processing ends.

In a case where the pin definition of the interface 26 and the pin definition of the interface 36 are not identical to each other (No in Step S01), the processing proceeds to Step S02. For example, in a case where the system controller 12 is replaced with another system controller 12 having a new function, a situation where a pin configuration (pin definition) of the interface 26 of the system controller 12 is changed and as a result the pin definition of the interface 26 and the pin definition of the interface 36 become different from each other can occur. Also in a case where the device controller 14 is replaced with another device controller 14, a similar situation can occur. In the following description, it is assumed that the system controller 12 is replaced with another system controller 12 having a new function.

The CPU 32 of the system controller 12 checks contents of settings of the registers for pins of the device controller 14 and checks whether or not a pin and a register corresponding to the new function are mounted in the device controller 14 (Step S02).

In a case where the pin and register are mounted in the device controller 14 (Yes in Step S02), the CPU 32 of the system controller 12 adds the new function to the device controller 14 (Step S03). Specifically, since a program file for realizing the new function is stored in the configuration memory 30 of the system controller 12, the CPU 32 causes the program file to be stored in the configuration memory 40 of the device controller 14. This constructs a circuit for realizing the new function on the CPLD 38 of the device controller 14. The CPU 42 of the device controller 14 may acquire the program file from the configuration memory 30 of the system controller 12 and cause the program file to be stored in the configuration memory 40.

In a case where the pin and register are not mounted in the device controller 14 (No in Step S02), the CPU 32 of the system controller 12 determines whether or not the new function can be used while restricting the new function on the basis of the pin definition of the interfaces 26 and 36 (Step S04).

In a case where the new function can be used while restricting the new function (Yes in Step S04), the CPU 32 restricts the new function (Step S05).

In a case where the new function cannot be used while restricting the new function (No in Step S04), the CPU 32 sets the new function unusable (Step S06).

As described above, processing based on the pin definition of the interface 26 and the pin definition of the interface 36 is executed.

The function matching processing is described in detail below by using specific examples. In the following Specific Examples 1 to 4, it is assumed that parallel connection is used as a method of connection between the interfaces 26 and 36.

### Specific Example 1

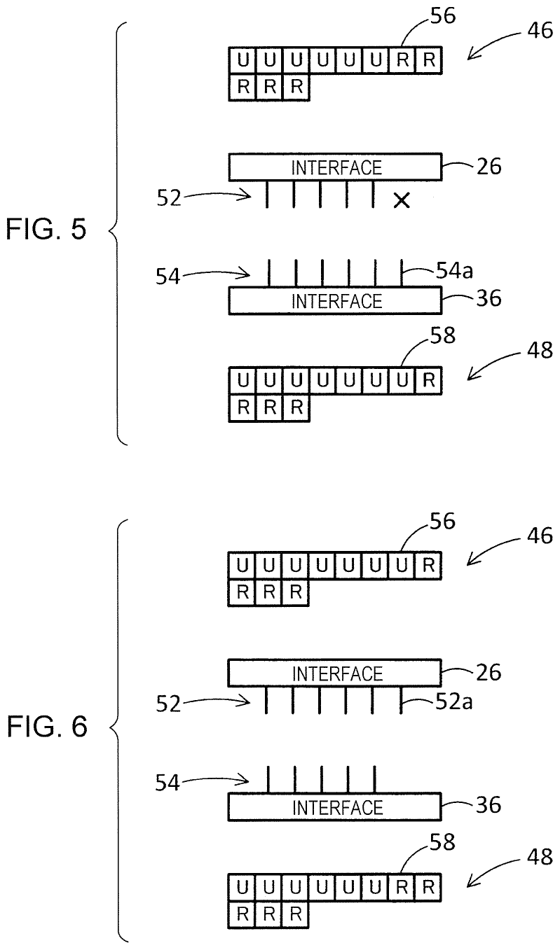

Specific Example 1 is described below with reference to FIG. 5. FIG. 5 illustrates contents of settings of registers, pin configurations, and the like. In Specific Example 1, the system controller 12 is replaced with a new system controller 12 having a new function, and the device controller 14 is not replaced. That is, the new-type system controller 12 and the old-type device controller 14 are connected to each other.

The interface 26 includes a pin group 52 including plural pins. The interface 36 includes a pin group 54 including plural pins. The pin group 52 and the pin group 54 are connected to each other, and thus the new-type system controller 12 and the old-type device controller 14 are physically connected (parallel connection).

In the interface 26 of the new-type system controller 12, a pin that originally existed has been removed. For example, a pin corresponding to (connected to) a pin 54a included in the pin group 54 of the old-type has been removed from the interface 26 of the new-type system controller 12 (indicated by the x mark in FIG. 5). The pin 54a is, for example, a pin used for transmission and reception of a power source control signal of Ethernet (Registered Trademark).

In this case, in the register 46 for pins of the system controller 12, information indicative of “R” indicating that the removed pin is not being used is stored in advance in a storage region 56 corresponding to the removed pin. For example, the information is stored in the register 46 in a production process of the new-type system controller 12. The same also applies to the following description.

In the registers 46 and 48, information indicative of “U” means that a physical pin corresponding to a storage region in which the information indicative of “U” is stored is mounted in an interface.

Since the pin 54a is mounted in the interface 36, information indicative of “U” indicating that the pin 54a is being used is stored in advance in a storage region 58 corresponding to the pin 54a in the register 48.

Since the pin corresponding to the pin 54a has been removed from the interface 26 as described above, there is mismatch in pin definition between the interface 26 and 36 in this part. In this case, processing of adding the new function, processing of restricting the new function, or processing for making the new function unusable is performed.

### Specific Example 2

Specific Example 2 is described below with reference to FIG. 6. FIG. 6 illustrates contents of settings of registers, pin configurations, and the like. In Specific Example 2, the system controller 12 is replaced with a new system controller 12 having a new function, and the device controller 14 is not replaced. That is, the new-type system controller 12 and the old-type device controller 14 are connected to each other.

The interface 26 of the new-type system controller 12 includes a pin 52a that has been newly added. The pin 52a is, for example, a pin used for transmission and reception of a signal for speculated rotation control of the fan 24 and transmission and reception of an LED blinking control signal.

In this case, information indicative of “U” indicating that the pin 52a that has been newly added is being used is stored in advance in a storage region 56 corresponding to the pin 52a in the register 46 for pins of the system controller 12.

Meanwhile, since a pin corresponding to (connected to) the pin 52a is not mounted in the interface 36, information indicative of “R” indicating that the pin is not being used is stored in advance in a storage region 58 corresponding to the pin in the register 48.

Since the pin 52a has been newly added to the interface 26 as described above, there is mismatch in pin definition between the interfaces 26 and 36 in this part. In this case, processing of adding the new function, processing of restricting the new function, or processing for making the new function unusable is performed.

### Specific Example 3

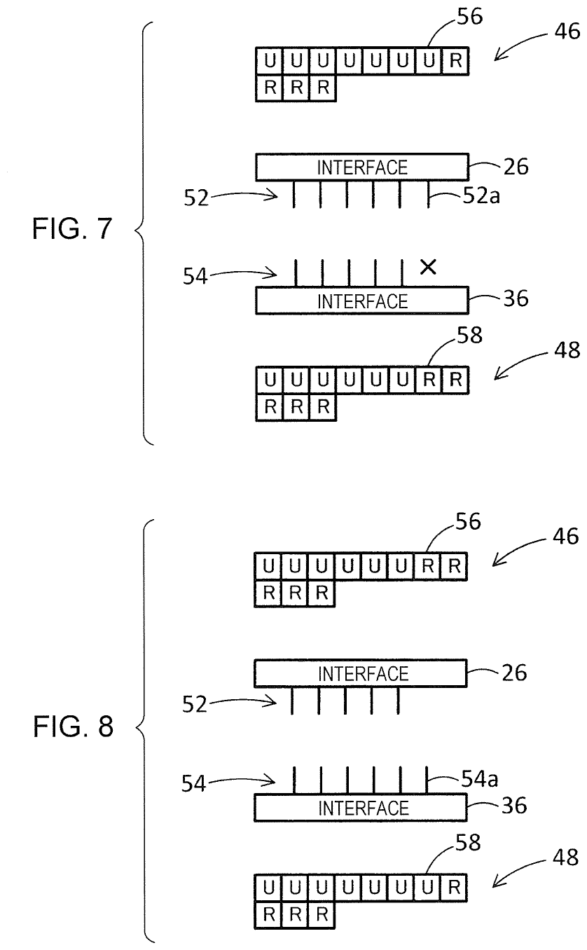

Specific Example 3 is described below with reference to FIG. 7. FIG. 7 illustrates contents of settings of registers, pin configurations, and the like. In Specific Example 3, the device controller 14 is replaced with a new device controller 14 having a new function, and the system controller 12 is not replaced. That is, the old-type system controller 12 and the new-type device controller 14 are connected to each other.

In the interface 36 of the new-type device controller 14, a pin that originally existed has been removed. For example, a pin corresponding to (connected to) a pin 52a included in the pin group 52 of the old type has been removed from the interface 36 of the new-type device controller 14 (indicated by the x mark in FIG. 7). The pin 52a is a pin used for transmission and reception of an interrupt signal from the device controller 14 to the system controller 12.

In this case, in the register 48 for pins of the device controller 14, information indicative of “R” indicating that the removed pin is not being used is stored in advance in a storage region 58 corresponding to the removed pin.

Since the pin 52a is mounted in the interface 36, information indicative of “U” indicating that the pin 52a is being used is stored in advance in a storage region 56 corresponding to the pin 52a in the register 46.

Since the pin corresponding to the pin 52a has been removed from the interface 36 as described above, there is mismatch in pin definition between the interface 26 and 36 in this part. In this case, processing of adding the new function, processing of restricting the new function, or processing for making the new function unusable is performed.

### Specific Example 4

Specific Example 4 is described below with reference to FIG. 8. FIG. 8 illustrates contents of settings of registers, pin configurations, and the like. In Specific Example 4, the device controller 14 is replaced with a new device controller 14 having a new function, and the system controller 12 is not replaced. That is, the old-type system controller 12 and the new-type device controller 14 are connected to each other.

The interface 36 of the new-type device controller 14 includes a pin 54a that has been newly added. The pin 54a is a pin used for transmission and reception of a control signal of a page memory, transmission and reception of a reset control signal of the page memory, and transmission and reception of a signal for high-speed or low-speed rotation control of the fan 24.

In this case, information indicative of “U” indicating that the pin 54a that has been newly added is being used is stored in advance in a storage region 58 corresponding to the pin 54a in the register 48 for pins of the device controller 14.

Meanwhile, since a pin corresponding to (connected to) the pin 54a is not mounted in the interface 26, information indicative of “R” indicating that the pin is not being used is stored in advance in a storage region 56 corresponding to the pin in the register 46.

Since the pin 54a has been newly added to the interface 36 as described above, there is mismatch in pin definition between the interfaces 26 and 36 in this part. In this case, processing of adding the new function, processing of restricting the new function, or processing for making the new function unusable is performed.

The following describes in detail processing performed in a case where the device controller 14 is replaced with a device controller 14 having a new function. The following describes, for example, a case where a function concerning improvement of quietness, a power consumption reducing function, or a function concerning improvement of viewability has been added as the new function.

### Function Concerning Improvement of Quietness

For example, it is assumed that the new-type device controller 14 has a new function of rotating the fan 24 at a high speed or a low speed and that the old-type device controller 14 has been replaced with the new-type device controller 14. A program file for realizing the new function is stored in the configuration memory 40 of the device controller 14. This constructs a circuit for realizing the new function on the CPLD 38 of the device controller 14. Meanwhile, the old-type system controller 12 is not replaced. Such a situation corresponds to Specific Example 4.

The pin 54a in the interface 36 of the device controller 14 is defined as a pin used for transmission and reception of a control signal concerning the new function.

In this case, in a case where a pin corresponding to (connected to) the pin 54a in the interface 36 of the device controller 14 is mounted in the interface 26 of the old-type system controller 12 and a register corresponding to the pin is mounted in the old-type system controller 12, the new function is added to the old-type system controller 12. Although such a pin is not mounted in the interface 26 in Specific Example 4, it is assumed here that the pin is mounted in the interface 26. For example, whether or not a pin is mounted or not may be detected by an electrical detection method.

Specifically, the CPU 32 of the old-type system controller 12 acquires the program file for realizing the new function from the configuration memory 40 of the device controller 14 and causes the program file to be stored in the configuration memory 30 of the system controller 12. This constructs a circuit for realizing the new function on the CPLD 28 of the system controller 12. In this way, the new function becomes executable by the image forming apparatus 10. Furthermore, the CPU 32 causes information indicative of “U” indicating that the pin corresponding to (connected to) the pin 54a is being used to be stored in a register (e.g., the storage region 56) corresponding to the pin corresponding to (connected to) the pin 54a. In this way, the first pin definition of the interface 26 and the second pin definition of the interface 36 match each other. The CPU 32 operates as an example of a matching unit.

Although the fan 24 is controlled by the device controller 14, a command to execute the control is sent from the system controller 12 to the device controller 14. The new function is also added to the system controller 12 so that the system controller 12 can give a command to execute high-speed or low-speed rotation control to the device controller 14. Since the new function is added to the system controller 12, the system controller 12 can give a command to execute the new function to the device controller 14, and the device controller 14 can rotate the fan 24 at a high speed or a low speed in accordance with the command. Furthermore, for example, a command to execute processing other than a command to control the fan 24 is sometimes given from the system controller 12 to the device controller 14. In a case where a device controller 14 having a new function for executing the processing is mounted in the image forming apparatus 10, a program file for realizing the new function is sent from the device controller 14 to the system controller 12 and is then stored in the configuration memory 30, as in the case of a program file concerning control of the fan 24. In this way, the new function becomes executable by the image forming apparatus 10. For example, a print command using a network is given from the system controller 12 to the device controller 14. Accordingly, in a case where a new function concerning printing using a network is added to the device controller 14, it is necessary to store a program file for realizing the new function in the system controller 12 and construct a circuit for realizing the new function on the CPLD 28 in order to allow the image forming apparatus 10 to execute the new function.

In a case where a pin corresponding to the pin 54a in the interface 36 of the device controller 14 is not mounted in the interface 26 of the old-type system controller 12 or in a case where a register corresponding to the pin is not mounted in the old-type system controller 12, the new function added to the new-type device controller 14 is restricted. For example, the CPU 32 does not acquire a program file for realizing the new function from the device controller 14. Furthermore, the CPU 32 causes information indicative of “R” indicating that the pin 54a is not being used to be stored in a register (the storage region 58) corresponding to the pin 54a. In this way, the first pin definition of the interface 26 and the second pin definition of the interface 36 match each other. The CPU 32 operates as an example of a matching unit.

Since the program file for realizing the new function is not stored in the configuration memory 30 of the system controller 12, a circuit for realizing the new function is not constructed on the CPLD 28. In this case, the system controller 12 sends, to the device controller 14, a control signal for turning the fan 24 on or off as a signal for controlling the fan 24. As a result, in the image forming apparatus 10, high-speed or low-speed rotation of the fan 24 is not realized and only on or off of the fan 24 is realized as operation of the fan 24.

### Power Consumption Reducing Function

For example, it is assumed that the new-type device controller 14 has a new function of self-refreshing a page memory and that the old-type device controller 14 has been replaced with a new-type device controller 14. A program file for realizing the new function is stored in the configuration memory 40 of the device controller 14. This constructs a circuit for realizing the new function on the CPLD 38 of the device controller 14. Meanwhile, the old-type system controller 12 is not replaced. Such a situation corresponds to Specific Example 4 described above.

Furthermore, the pin 54a in the interface 36 of the device controller 14 is defined as a pin used for transmission and reception of a control signal concerning the new function.

In this case, in a case where a pin (corresponding to (connected to) the pin 54a in the interface 36 of the device controller 14 is mounted in the interface 26 of the old-type system controller 12 and where a register corresponding to the pin is mounted in the old-type system controller 12, the new function is added to the old-type system controller 12. Although such a pin is not mounted in the interface 26 in Specific Example 4, it is assumed here that the pin is mounted in the interface 26.

A program file for realizing the new function is sent from the configuration memory 40 of the device controller 14 to the configuration memory 30 of the system controller 12 and is then stored in the configuration memory 30, as in the case of addition of the new function of the fan 24. This constructs a circuit for realizing the new function on the CPLD 28 of the system controller 12. In this way, the new function becomes executable by the image forming apparatus 10. Furthermore, the CPU 32 causes information indicative of “U” indicating that the pin corresponding to (connected to) the pin 54a is being used to be stored in a register (e.g., the storage region 56) corresponding to the pin corresponding to (connected to) the pin 54a. In this way, the first pin definition of the interface 26 and the second pin definition of the interface 36 match each other.

In a case where a pin corresponding to the pin 54a in the interface 36 of the device controller 14 is not mounted in the interface 26 of the old-type system controller 12 or in a case where a register corresponding to the pin is not mounted in the old-type system controller 12, the new function added to the new-type device controller 14 is restricted. The CPU 32 does not acquire the program file for realizing the new function from the device controller 14 and causes information indicative of “R” indicating that the pin 54a is not being used to be stored in a register (the storage region 58) corresponding to the pin 54a. In this way, the first pin definition of the interface 26 and the second pin definition of the interface 36 match each other. In this case, self-refreshing of a page memory is not executed.

### Function Concerning Improvement of Viewability

For example, it is assumed that the new-type system controller 12 has a new function of controlling blinking of an LED and that the new-type system controller 12 is replaced with the new-type system controller 12. A program file for realizing the new function is stored in the configuration memory 30 of the system controller 12. This constructs a circuit for realizing the new function on the CPLD 28 of the system controller 12. Meanwhile, the old-type device controller 14 is not replaced. Such a situation corresponds to Specific Example 2 described above.

Furthermore, the pin 52a in the interface 26 of the system controller 12 is defined as a pin used for transmission and reception of a control signal concerning the new function.

In this case, a pin corresponding to (connected to) the pin 52a in the interface 26 of the system controller 12 is mounted in the interface 36 of the old-type device controller 14 and where a register corresponding to the pin is mounted in the old-type device controller 14, the new function is added to the old-type device controller 14. Although such a pin is not mounted in the interface 36 in Specific Example 2, it is assumed here that the pin is mounted in the interface 36.

Specifically, the CPU 42 of the old-type device controller 14 acquires the program file for realizing the new function from the configuration memory 30 of the system controller 12 and causes the program file to be stored in the configuration memory 40 of the device controller 14. This constructs a circuit for realizing the new function on the CPLD 38 of the device controller 14. In this way, the new function becomes executable by the image forming apparatus 10. Furthermore, the CPU 42 causes information indicative of “U” indicating that the pin corresponding to (connected to) the pin 52a is being used to be stored in a register (e.g., the storage region 58) corresponding to the pin corresponding to (connected to) the pin 52a. In this way, the first pin definition of the interface 26 and the second pin definition of the interface 36 match each other. The CPU 42 operates as an example of a matching unit.

In a case where a pin corresponding to the pin 52a in the interface 26 of the system controller 12 is not mounted in the interface 36 of the old-type device controller 14 or in a case where a register corresponding to the pin is not mounted in the old-type device controller 14, the new function added to the new-type system controller 12 is restricted. For example, the CPU 42 does not acquire the program file for realizing the new function from the system controller 12. Furthermore, the CPU 42 causes information indicative of “R” indicating that the pin 52a is not being used to be stored in a register (the storage region 56) corresponding to the pin 52a. In this way, the first pin definition of the interface 26 and the second pin definition of the interface 36 match each other. The CPU 42 operates as an example of a matching unit.

Since the program file for realizing the new function is not stored in the configuration memory 40 of the device controller 14, a circuit for realizing the new function is not constructed on the CPLD 38. In this case, the system controller 12 sends, to the device controller 14, a control signal for turning an LED on or off as a signal for controlling the LED. As a result, in the image forming apparatus 10, blinking control of the LED is not realized and only on or off of the LED is realized as operation of the LED.

In the present exemplary embodiment, in a case where there is mismatch between the first pin definition and the second pin definition, the first pin definition or the second pin definition is changed so that the first pin definition and the second pin definition match each other. Furthermore, a new function is added from one of the controllers to the other one of the controllers or the new function is restricted. This makes it possible to use a function of the image forming apparatus 10 as compared with a case where a function of the image forming apparatus 10 is completely stopped upon occurrence of mismatch between the interfaces 26 and 36.

In a case where a method of connection between the interfaces 26 and 36 is serial connection, a new function is made usable by supply of a program file from the one of controllers to the other one of the controllers and change of contents of settings of registers, as in the case where the method of connection between the interfaces 26 and 36 is parallel connection.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a first controller that has a first interface and performs control that does not depend on hardware;
a second controller that has a second interface connected to the first interface, is connected to the first controller through a communication path, and performs control that depends on the hardware; and
a matching unit that, in a case where there is mismatch between first pin definition of the first interface and second pin definition of the second interface, causes a function of the first controller and a function of the second controller to match each other by changing the first pin definition or the second pin definition so that the first pin definition and the second pin definition match each other.

2. The information processing apparatus according to claim 1, wherein
in a case where there is mismatch between the first pin definition and the second pin definition, the matching unit restricts, as function matching, a function that has been newly added to any one of the first controller and the second controller and that corresponds to the mismatch in pin definition by changing the first pin definition or the second pin definition.

3. The information processing apparatus according to claim 2, wherein
the first pin definition is decided by at least contents of a first register connected to a pin of the first interface;
the second pin definition is decided by at least contents of a second register connected to a pin of the second interface; and
the matching unit restricts the function that has been newly added in a case where a register corresponding to a register to which the function that has been newly added is allocated in the one of the first controller and the second controller is not mounted in the other one of the first controller and the second controller.

4. The information processing apparatus according to claim 1, wherein
in a case where there is mismatch between the first pin definition and the second pin definition, the matching unit, as function matching, adds a function that has been newly added to any one of the first controller and the second controller and that corresponds to the mismatch in pin definition to the other one of the first controller and the second controller by changing the first pin definition or the second pin definition.

5. The information processing apparatus according to claim 4, wherein
the first pin definition is decided by at least contents of a first register connected to a pin of the first interface;
the second pin definition is decided by at least contents of a second register connected to a pin of the second interface; and
the matching unit adds the newly-added function to the other one of the first controller and the second controller in a case where a register corresponding to a register to which the newly-added function is allocated in the one of the first controller and the second controller is mounted in the other one of the first controller and the second controller.

6. The information processing apparatus according to claim 5, wherein
the matching unit sends control information for executing the new function from the one of the first controller and the second controller to the other one of the first controller and the second controller.

7. An information processing apparatus comprising:
first controlling means for performing control that does not depend on hardware, the first controlling means having a first interface;
second controlling means for performing control that depends on the hardware, the second controlling means having a second interface connected to the first interface and being connected to the first controller through a communication path; and
matching means for, in a case where there is mismatch between first pin definition of the first interface and second pin definition of the second interface, causing a function of the first controller and a function of the second controller to match each other by changing the first pin definition or the second pin definition so that the first pin definition and the second pin definition match each other.
